(19) United States
(12) Patent Application Publication
(10) Pub. No.: US 2024/0378733 A1
(43) Pub. Date: Nov. 14, 2024

(54) SYSTEMS AND METHODS FOR VISUAL NAVIGATION

(71) Applicant: Palantir Technologies Inc., Denver, CO (US)

(72) Inventors: Joseph Adam Driscoll, Bentleyville, OH (US); Ethan Van Andel, Berkeley, CA (US); Mary Cameron, Washington, DC (US); Miles Sackler, Seattle, WA (US); Stephen Ramsey, Mountain View, CA (US)

(21) Appl. No.: 18/655,573

(22) Filed: May 6, 2024

Related U.S. Application Data
(60) Provisional application No. 63/465,392, filed on May 10, 2023.

(51) Int. Cl. G06T 7/246; G01C 21/20; G06T 7/277; G06T 7/33; G06T 7/73

(52) U.S. Cl. CPC G06T 7/248; G01C 21/20; G06T 7/277; G06T 7/337; G06T 7/73; G06T 2207/10016; G06T 2207/10032; G06T 2207/30244

(57) ABSTRACT

Systems and methods for visual navigation are provided. An example method includes receiving a plurality of video frames from an image sensor disposed on an aircraft, and generating an image-based transform based on the plurality of video frames. In some examples, the image-based transform is associated with a movement of one or more image features and a movement of the image sensor. In some examples, the method further includes: determining an image-based motion associated with the aircraft based on the image-based transform, generating a georegistration transform based on at least one video frame of the plurality of video frames and a reference image, determining a georegistration-based geolocation associated with the aircraft based on the georegistration transform, and determining an aircraft geolocation by applying a non-linear Kalman filter to the image-based motion and the georegistration-based geolocation,

### CROSS REFERENCE TO RELATED APPLICATIONS

This application claims priority to U.S. Provisional Application No. 63/465,392, entitled “SYSTEMS AND METHODS FOR VISUAL NAVIGATION,” and filed on May 10, 2023, which is incorporated by reference herein for all purposes in its entirety.

### TECHNICAL FIELD

Certain embodiments of the present disclosure relate to navigation. More particularly, some embodiments of the present disclosure relate to visual navigation.

### BACKGROUND

There are different types of navigation, including visual navigation and instrument navigation. In some examples, instrument navigation may include navigation done with the assistance of a global positioning system (GPS). An example context of navigation includes navigating an aircraft.

Hence, it is desirable to improve techniques for visual navigation.

### SUMMARY

Certain embodiments of the present disclosure relate to navigation. More particularly, some embodiments of the present disclosure relate to visual navigation.

At least some aspects of the present disclosure are directed to a method for visual navigation. In some examples, the method includes: receiving a plurality of video frames from an image sensor disposed on an aircraft, and generating an image-based transform based on the plurality of video frames. In some examples, the image-based transform is associated with a movement of one or more image features and a movement of the image sensor. In some examples, the method further includes: determining an image-based motion associated with the aircraft based on the image-based transform, generating a georegistration transform based on at least one video frame of the plurality of video frames and a reference image, determining a georegistration-based geolocation associated with the aircraft based on the georegistration transform, and determining an aircraft geolocation by applying a non-linear Kalman filter to the image-based motion and the georegistration-based geolocation. In some examples, the method is performed using one or more processors.

At least some aspects of the present disclosure are directed to a system for visual navigation. In some examples, the system includes at least one processor and at least one memory storing instructions that, when executed by the at least one processor, cause the system to perform a set of operations. In some examples, the set of operations includes: receiving a plurality of video frames from an image sensor disposed on an aircraft, and generating an image-based transform based on the plurality of video frames. In some examples, the image-based transform is associated with a movement of one or more image features and a movement of the image sensor. In some examples, the set of operations further includes: determining an image-based motion associated with the aircraft based on the image-based transform, generating a georegistration transform based on at least one video frame of the plurality of video frames and a reference image, determining a georegistration-based geolocation associated with the aircraft based on the georegistration transform, and determining an aircraft geolocation by applying a non-linear Kalman filter to the image-based motion and the georegistration-based geolocation.

At least some aspects of the present disclosure are directed to a method for visual navigation. In some examples, the method includes: receiving a plurality of video frames from an image sensor disposed on an aircraft, and generating an image-based transform based on the plurality of video frames. In some examples, the image-based transform is associated with a movement of one or more image features and a movement of the image sensor. In some examples, the method further includes: determining an image-based motion associated with the aircraft based on the image-based transform, generating a georegistration transform based on at least one video frame of the plurality of video frames and a reference image, determining a georegistration-based geolocation associated with the aircraft based on the georegistration transform, receiving metadata associated with the aircraft, and estimating an aircraft geolocation by applying a non-linear Kalman filter to the image-based motion, the georegistration-based geolocation, and the metadata. In some examples, the method is performed using one or more processors.

Depending upon embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 is an illustrative diagram for a visual navigation environment or workflow, according to certain embodiments of the present disclosure.

FIG. 2 is a simplified diagram showing a method for visual navigation, according to certain embodiments of the present disclosure.

FIG. 3 is a simplified diagram showing a method for visual navigation, according to certain embodiments of the present disclosure

FIG. 4 is a simplified diagram showing a software architecture for a video georegistration system, according to certain embodiments of the present disclosure.

FIG. 5 is a simplified diagram showing a method for video georegistration, according to certain embodiments of the present disclosure.

FIG. 6 is a simplified diagram showing a method for generating an image transformation, according to certain embodiments of the present disclosure

FIG. 7 illustrates a simplified diagram showing a computing system, according to certain embodiments of the present disclosure.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

Although illustrative methods may be represented by one or more drawings (e.g., flow diagrams, communication flows, etc.), the drawings should not be interpreted as implying any requirement of, or particular order among or between, various steps disclosed herein. However, some embodiments may require certain steps and/or certain orders between certain steps, as may be explicitly described herein and/or as may be understood from the nature of the steps themselves (e.g., the performance of some steps may depend on the outcome of a previous step). Additionally, a “set.” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information. As used herein, the term “receive” or “receiving” means obtaining from a data repository (e.g., database), from another system or service, from another software, or from another software component in a same software. In certain embodiments, the term “access” or “accessing” means retrieving data or information, and/or generating data or information.

Conventional systems and methods for navigation are often not capable of navigation when GPS (global positioning system) is not available. Conventional systems and methods typically use GPS information to conduct navigation, such that the system cannot conduct navigation in areas where GPS is not available, also referred to as GPS-denied environments.

Various embodiments of the present disclosure can achieve benefits and/or improvements by a computing system, for example, using visual data (e.g., videos) and/or motion data for navigation. In some embodiments, benefits include significant improvements, including, for example, performing navigation and generating location information of an aircraft, even if the aircraft is in an area where GPS is not available. In some embodiments, the location information may be provided to one or more displays, e.g. for enabling controlled navigation of the aircraft by a user via remote control. In some embodiments, the location information may be provided to one or more control systems that may perform certain technical actions such as, but not limited to, automated controlled navigation of the aircraft via a remote control, based on the location information. In certain embodiments, other benefits include improved accuracy for navigation, for example, using visual data and/or motion data. In some embodiments, benefits further include capability of processing visual data from sensors of more than one sensor type and using the visual data for navigation. In certain embodiments, systems and methods are configured to use visual data, motion data, and/or georegistration for navigation.

According to certain embodiments, systems (e.g., navigation systems) may utilize one or more unmanned aircrafts (UA) (e.g., unmanned aerial vehicles, drones) with camera feeds to monitor and analyze areas of interest. In some embodiments, as used herein, an aircraft refers to an aircraft, an unmanned aircraft, an unmanned aerial vehicle (UAV), a drone, and/or the like. In some use cases, it is important (e.g., critical) that the user knows the geolocation of the drone and camera imagery to a high degree of accuracy and precision. In some conventional systems, the problem of geolocating the drone may be solved by taking GPS (global position system) measurements, however, aircraft often fly in areas where GPS measurements are unavailable. To solve this problem, in certain embodiments, systems and methods may use a visual navigation solution (e.g., a visual navigation software, a visual navigation software module, a visual navigation module, a visual navigation system), for example, involving the integration of software and algorithmic techniques to track the motion of the aircraft.

According to some embodiments, systems and methods may include the visual navigation using one or more sensor inference platform (SIP) processors. In certain embodiments, SIP orchestrates between the input sensor data and output feeds. As an example, SIP is a model orchestrator, also referred to as a model and/or sensor orchestrator, for one or more models and/or one or more sensors (e.g., sensor feeds). In some embodiments, a model, or referred to as a computing model or as an algorithm, includes a model to process data. In some embodiments, a model includes, for example, an AI model, a machine learning (ML) model, a deep learning (DL) model, an image processing model, a physics model, simple heuristics, rules, a math model, other computing models, and/or a combination thereof. For example, one or more components of SIP are utilizing open standard formats (e.g., input data format, output data format). As an example, SIP takes care of the decoding of the input data, orchestration between processors and artificial intelligence (AI) models, and then packages up the results into an open output format for downstream consumers. According to some embodiments, a system includes one or more SIPs to orchestrate one or more sensors, one or more edge devices, one or more user devices, and/or one or more models. In certain embodiments, at least some of the one or more sensors, one or more edge devices, one or more user devices, and one or more models are each associated with an SIP.

According to certain embodiments, a visual navigation module integrated with an SIP allows the visual navigation module to be deployable in a wide variety of settings including, for example, on the edge, to operate agnostic of the format of the incoming video stream. In some embodiments, such implementation may separate this solution from others.

According to some embodiments, a user can stream an aircraft (e.g., a drone) video feed through SIP, which associates metadata related to the aircraft (e.g., velocity, speed, heading, orientation, altitude, etc.) to each video frame and passes the information along to the visual navigation module. In certain embodiments, the metadata, along with an initial estimate of the UA location, enables tracking (e.g., rudimentary tracking) of the aircraft, but in some cases, such a solution may be insufficient for long-term accuracy.

According to certain embodiments, through a process of feature extraction and feature matching, a visual navigation system can use the motion of the pixels from a frame to frame analysis to determine a motion of the image sensor (e.g., a camera, a video camera). In some embodiments, the visual navigation system can apply a georegistration algorithm to the video frame to find its location which can then be used to determine the aircraft's location.

According to some embodiments, the georegistration implementation uses an image matching technique that works both within and across two or more sensor types including, for example, an electro-optical (EO) sensor type, infrared (IR) sensor type, synthetic aperture radar (SAR) sensor type, and/or the like. In certain embodiments, such georegistration implementation has one or more advantages over other techniques that only work with a single type of data. In some embodiments, the visual navigation according to certain embodiments also works well in low-detail natural terrain, which is a common area of struggle in image matching. In certain examples, this is an important component of this technology.

According to certain embodiments, two inputs (e.g., metadata and pixel motion), provide no actual geolocation information and result in compounding error. In some embodiments, incorporating of georegistration results is what allows this solution to remove this compounding error.

According to some embodiments, three pieces of information are fed into an unscented Kalman filter (UKF) which, when supplied with an initial estimate of the aircraft geolocation, can continuously track the position of the aircraft throughout the duration of its flight. In some examples, at least two pieces of information are fed into the UKF, such as to continuously track the position of the aircraft throughout the duration of its flight. In certain embodiments, the implementation of this solution involves the integration of the SIP and the design of the UKF. In some embodiments, the filter design involves determining the relevant information to track and/or model how an aircraft moves and how its sensors behave.

According to certain embodiments, the system includes the integration of these various components, including two parts. First, in some embodiments, the visual navigation system can ingest one or more video streams (e.g., arbitrary video streams). In certain embodiments, the system can combine the metadata (e.g., velocity, speed, heading, orientation, altitude of an aviation system) with the imagery on a per-frame basis. In some embodiments, a video frame, also referred to as an image frame or a frame, is an image in a sequence of images or an image in a video. Second, in certain embodiments, the system can include an image matching georegistration solution (e.g., an advanced image matching georegistration solution) to match against a wide range of data as an input. In some embodiments, the solution (e.g., the system) making use of georegistration allows the solution to get precise geolocation measurements consistently during flight-time, even while operating in a GPS-denied (e.g., no GPS information) setting. Some conventional navigation systems may not have access to or integrate with a georegistration solution. Some conventional navigation system may not have access to or integrate with an image matching georegistration solution. In some embodiments, this solution may integrate with existing workflow and/or one or more sensors that the aircraft have.

According to some embodiments, a visual navigation system includes and/or is integrated with a georegistration system (e.g., georegistration for videos, georegistration for full-motion videos). In certain embodiments, a georegistration system (e.g., a georegistration service) is configured to receive (e.g., obtain) a video from a video recording platform (e.g., an imaging sensor on a VA) with location information (e.g., telemetry data) and align the received video with a reference frame (e.g., a dynamic reference frame, a reference image, a map) so the georegistration system can determine the geospatial coordinates, also referred to as geo-coordinates, of the video.

According to certain embodiments, a georegistration system incorporates one or more techniques including, for example, georectification, orthorectification, orthorectification, and/or the like. In some embodiments, georectification refers to assigning geo-coordinates to an image. In certain embodiments, orthorectification refers to warping an image to match the top-down view. In some examples, orthorectification includes reshaping hillsides and such so it looks like the image was taken directly from overhead rather than at a side angle. In some embodiments, georegistration refers to refining the geo-coordinates of a video, for example, based on reference data.

In certain embodiments, image registration (e.g., georegistration) refers to, given an input image and one or more reference images, finding a transform mapping the input image to the corresponding part of the one or more reference images. In some embodiments, video registration (e.g., georegistration) refers to, given an input video and one or more reference images, finding a transform or a sequence of transforms mapping the input video including one or more video frames to the corresponding part of the one or more reference images and use the transforms to generate the registered video. In certain embodiments, image/video georegistration has one or more challenges: 1) images/videos may have visual variations, for example, lighting changes, temporal changes (e.g., seasonal changes), sensor mode (e.g., electro-optical (EO), infrared (IR), synthetic-aperture radar (SAR), etc.); 2) images/videos may have minimal structured content (e.g., forest, fields, water, etc.); 3) images/videos may have noise (e.g., image noise for SAR images); and 4) images/videos may have rotation, scale, and/or perspective changes.

According to some embodiments, the georegistration system is configured to receive a video (e.g., a streaming video) and choose one or more video frames (e.g., video images) and one or more selected derivations (e.g., derived composites of multiple video frames, a pixel grid of a video frame, etc.) in video frames, also referred to as templates (e.g., 60 by 60 pixels). In certain embodiments, a video georegistration uses selected video frames (e.g., every one second) and templates that can be less time-consuming. In some embodiments, the georegistration system performs georegistration of the templates, collects desirable matches, computes image transformation and generates a sequence of registered video frames (e.g., georegistered video frames) and a registered video (e.g., georegistered video).

According to certain embodiments, the georegistration system computes an image representation (e.g., one or more feature descriptors) of the templates for georegistration. In some embodiments, the georegistration system computes the angle weighted oriented gradients (AWOG) representation of the templates for georegistration. In certain embodiments, the georegistration system compares the AWOG representation of the template with reference imagery (e.g., reference image) to determine a match and/or a match score, for example, the template sufficiently matched (e.g., 100%, 80%) the reference imagery. In some embodiments, the georegistration system reiterates the process to find enough matched templates. According to certain embodiments, the georegistration system uses the matched templates to perform georegistration of the image or the video frame. In some embodiments, the matched templates might be noisy and/or irregular.

According to some embodiments, video georegistration is accomplished by a collection of individual components of a georegistration system. In certain embodiments, each of these is an individual SIP (sensor inference platform) (e.g., a software orchestrator, a model and/or sensor orchestrator) processor (e.g., a computing unit implementing SIP), running in parallel and/or behind an aggregation filter processor (e.g., a computing unit implementing SIP). In some embodiments, a processor refers to a computing unit implementing a model (e.g., a computational model, an algorithm, an AI model, etc.). In certain embodiments, a model, also referred to as a computing model, includes a model to process data. A model includes, for example, an AI model, a machine learning (ML) model, a deep learning (DL) model, an image processing model, an algorithm, a rule, other computing models, and/or a combination thereof.

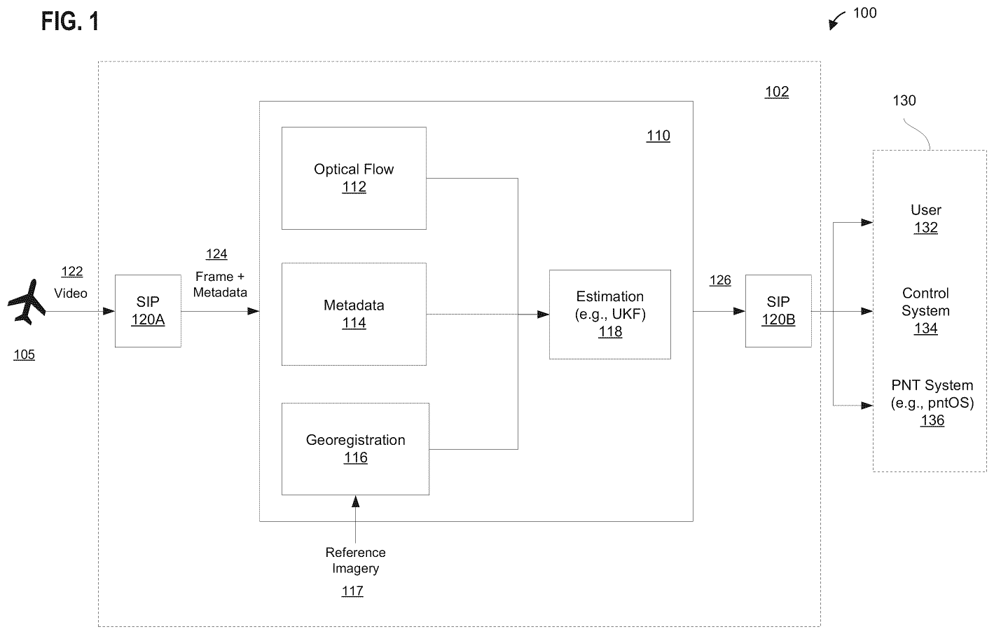

FIG. 1 is an illustrative diagram for a visual navigation environment or workflow 100, according to certain embodiments of the present application. FIG. 1 is merely an example. One of the ordinary skilled in the art would recognize many variations, alternatives, and modifications. For example, some of the components may be expanded, integrated, and/or combined. Other components may be inserted into those noted above. Depending upon the embodiment, the arrangement of components may be interchanged with others replaced. Further details of these components are found throughout the present disclosure.

According to certain embodiments, the visual navigation environment or workflow 100 includes one or more aircrafts 105, a visual navigation system 102, and one or more output systems 130. In some embodiments, the aircraft 105 may be an aircraft, an unmanned aircraft, an unmanned aerial vehicle (UAV), a drone, and/or the like In some embodiments, the visual navigation system 102 includes an SIP 120A (e.g., a software orchestrator, a model and/or sensor orchestrator, etc.), a visual navigation module 110 (e.g., a visual navigation software, a visual navigation system, etc.), and an SIP 120B. In certain embodiments, the visual navigation module 110 includes an optical flow processor 112, metadata 114, a georegistration processor 116, and/or an estimation processor 118. In some embodiments, the different components in the visual navigation module 110 are expected to run at different FPS (frames-per-second) values, based on respective computational demands. In certain embodiments, the SIP 120A receives one or more videos 122, for example, via a video stream. In some embodiments, the one or more videos 122 include a sequence of images (e.g., frames).

According to some embodiments, the visual navigation system 102 and/or the visual navigation module 110 includes a number of technical components working in concert to deliver accurate PNT (positioning, navigation, and timing) in GPS-denied environments. In certain embodiments, the visual navigation module 110 takes an input video stream or a series of image frames with metadata 114 (e.g., telemetry data). In some embodiments, the visual navigation module 110 outputs geolocation information 126 (e.g., PNT information, location information and timing information, three-dimensional (3D) position information, etc.). In certain embodiments, the PNT information 126 is output, for example, via the SIP 120B, to one or more output systems, for example, structured for tracking and telemetry, active control, or integration into positioning systems (e.g., APNT (assured positioning navigation and timing) systems, etc.) including, for example, such as a PNT open architecture (e.g., pntOS).

According to certain embodiments, the SIP 120A and/or 120B allows a user or a system to pass the data through a configurable data processing and analysis pipeline. In some embodiments, the SIP 120A is configured to ingest various videos 122 (e.g., video streams, arbitrary video streams) and associate the metadata (e.g., location metadata, aircraft metadata) to each frame of a video. In certain embodiments, this allows for rapid cross-platform deployability, rather than being locked to a specific sensor/platform integration.

According to some embodiments, the optical flow processor 112 (e.g., a processing unit implementing an optical flow software module) can measure pixel motion between two video frames (e.g., image frames, frames) through a process of feature extraction and feature matching. In some embodiments, the optical flow processor 112 can determine an image-based transform and an image-based motion (e.g., a pixel motion, an image feature motion, etc.). In certain embodiments, the first frame is analyzed for areas that are relatively distinct within the image. In some embodiments, the second frame is analyzed to find the same or similar features of that which were extracted from the first frame. In certain embodiments, each successful match creates a motion vector (e.g., how that small area moved from the first frame to the second frame). In some embodiments, the one or more vectors are combined to determine an image-based transform (e.g., a frame-to-frame transform) based at least in part on the pixel motions (e.g., the transform from the first frame to the second frame). In certain embodiments, the image-based transform includes a motion vector. In certain embodiments, this transform can provide a transformation from pixel space to camera-space and thus gives a measurement of the camera's motion (e.g., the motion of the image sensor disposed on an aircraft). In some embodiments, the transformation from pixel space to camera-space is calculated using the metadata associated with the aircraft.

According to certain embodiments, metadata 114 includes, for example, speed, heading, altitude, and orientation (e.g., of and/or associated with the aircraft 105). In certain embodiments, the metadata 114 includes a motion vector. In some embodiments, the visual navigation system 102 includes measurement of metadata 114 including, for example, the speed, heading, altitude, and orientation of the aircraft 105. In certain embodiments, while there is no consistent GPS data available, the visual navigation system 102 includes measurement of metadata 114 including, for example, the speed, heading, altitude, and orientation of the aircraft 105. In some embodiments, the visual navigation system 102 can track the aircraft's position. In some embodiments, lossy/unreliable GPS information as well as externally supplied initialization (e.g., initial position) can be integrated to the metadata 114 to improve the accuracy and reliability of the solution.

According to some embodiments, the georegistration processor 116 is configured to implement the process of aligning a georectified image to a reference image to reduce the location-based error in the initial rectification. In certain examples, the georegistration processor 116 uses a georectification algorithm to generate a georectified image. In certain embodiments, the georegistration processor 116 uses an algorithm that allows for registration across multiple image modalities (EO, IR, SAR) and in a wide array of environments that defeat traditional registration algorithms. In some embodiments, because georegistration can determine, with high precision and accuracy, the location of an image (e.g., an image frame, a video frame), assuming a transform between the imagery and the camera itself can be determined, the visual navigation module 110 can determine a georegistration transform to determine the location of the aircraft. In some embodiments, the georegistration transform is a transform between the geographic location of a first image and the geographic location of a second image.

According to certain embodiments, the visual navigation module 110 and/or the georegistration processor 116 (e.g., a georegistration system) can use a pointing angle of an imaging sensor disposed on the aircraft 105 and/or metadata of the pointing angle to determine the georegistration transform, which is also referred to as geolocation correction or geolocation transform. In some embodiments, the georegistration processor 116 uses reference imagery 117 in the georegistration process. In certain embodiments, reference imagery refers to a set of pre-registered imagery for one or more georegistration algorithms to register a new image (e.g., new imagery, incoming imagery, new image frame, incoming image frame, etc.). In some embodiments, the visual navigation module 110 and/or the georegistration processor 116 can retrieve reference imagery 117 from a component, an external component, a third-party dataset (e.g., a custom online map dataset for websites or applications, a custom dataset), a third-party system, and/or the like.

According to some embodiments, the visual navigation module 110 includes an estimation processor 118 that can receive one or more inputs including one or more image-based motions (e.g., pixel motions) from the optical flow processor 112, metadata 114 (e.g., motion metadata), and/or georegistration-based geolocations (e.g., geolocation correction(s)) from the georegistration processor 116. In certain embodiments, the estimation processor 118 can implement one or more estimation techniques and/or machine learning applications including, for example, a nonlinear Kalman filter, an unscented Kalman filter, an extended Kalman filter, and/or the like.

According to certain embodiments, the estimation processor 118 combines the one or more inputs to generate an estimate (e.g., a highly accurate estimate) of the aircraft location. In some embodiments, the estimation processor 118 uses an unscented Kalman filter to receive the one or more inputs (e.g., image-based motions, motion metadata, georegistration-based geolocations) to generate an estimate of the aircraft location. In certain embodiments, a Kalman filter includes a Bayesian state estimation technique that combines a prediction of how a given process behaves and a measurement of the current state. In some embodiments, the usage of the prediction and the measurement improves accuracy in the final state estimate, for example, compared with other techniques. In certain embodiments, an unscented Kalman filter is an extension of a Kalman filter that is configured to handle non-linearity. In some embodiments, the estimation processor 118 can incorporate a behavior model (e.g., a behavior model of the aircraft) that predicts how an aircraft behaves over time.

According to some embodiments, the visual navigation system 102 can provide one or more outputs 126 including, for example, the aircraft location, via the SIP 120B. In certain embodiments, the one or more outputs 126 can be integrated with or input into one or more output systems 130 (e.g., external systems) including, for example, one or more user systems 132, one or more control systems 134, one or more location systems 136 (e.g., a positioning, navigation, and timing-based operating systems, such as pntOS from the PNT open architecture, etc.).

According to certain embodiments, the georegistration processor 116 includes a calibration module (e.g., a calibration processor) to perform calibration to video frames at a selected FPS. In some embodiments, the calibration module can perform calibration to video frames at full FPS, for example, each video frame is calibrated. In certain embodiments, the calibration module uses historical telemetry data (e.g., past telemetry) and/or any corrections (e.g., baked-in corrections). In some embodiments, the calibration module requires lightweight computational cost (e.g., a few milliseconds, a couple of milliseconds).

According to some embodiments, the optical flow processor 112 processes video frames at a low FPS (e.g., 5 FPS, adaptive FPS). In certain embodiments, the visual navigation system 102 and/or the optical flow processor 112 computes an optical-flow-based motion model to provide an alternative, smoothed estimate of the motion of one or more objects in the video. In some embodiments, depending on performance profiles, the visual navigation system 102 moves the computational kernel for the optical flow processor 112 into a specific library (e.g., a C++ library). In certain embodiments, a DEM (digital elevation model) or similar data model (e.g., digital terrain model) can translate visual motion to estimated physical motion. In some embodiments, the optical-flow processor requires middleweight computational cost (e.g., tens of milliseconds or more). In certain embodiments, the optical-flow processor extracts relative motions of objects from video frames to make corrections.

According to certain embodiments, the georegistration processor 116 does reference georegistration periodically (e.g., 1 FPS or less). In some embodiments, the reference georegistration processor 116 registers selected video frames or some derived composite against reference imagery. In certain embodiments, the visual navigation system 102 and/or the georegistration processor 116 may use the video frame itself or use compositing multiple frames to get more data. In some embodiments, the visual navigation system 102 and/or the georegistration processor 116 may compare against overhead reference imagery or pre-project the reference or input imagery based on the predicted look angle. In certain embodiments, the visual navigation system 102 and/or the georegistration processor 116 may use various algorithms (e.g., class of algorithm) including, for example, algorithms to support multimodal (e.g., EO (electro-optical) and IR (infrared)) results. In some embodiments, depending on performance profiles, the visual navigation system 102 moves the computational kernel for the georegistration processor 116 into a specific library (e.g., a C++ library).

In some embodiments, the georegistration processor 116 requires heavyweight computational cost (e.g., less than 1 second). In certain embodiments, the calibration module processes video frames at a first frame rate (e.g., once every frame, once every other frame, once every J frames). In some embodiments, a frame rate refers to the frequency (e.g., frames-per-second (FPS)) of video frames being used and/or how often a video frame in a sequence of video frames is used. In some embodiments, the optical flow processor 112 processes video frames at a second frame rate (e.g., once every M frames). In certain embodiments, the georegistration processor 116 processes video frames at a third frame rate (e.g., once every N frames). In some embodiments, the first frame rate is higher than the second frame rate. In certain embodiments, the second frame rate is higher than the third frame rate. In some embodiments, J<M<N, for the frame rates.

According to certain embodiments, the georegistration processor 116 processes video frames for reference georegistration at a dynamic frame rate. In some embodiments, the georegistration processor 116 performs georegistration at a first frame rate at a first time. In certain embodiments, the georegistration processor 116 performs georegistration at a second frame rate at a second time, where the first frame rate is different from the second frame rate. In some embodiments, the georegistration processor 116 is configured to perform georegistration when there are available processing resources (e.g., computing processing unit (CPU), graphics processing unit (GPU)).

According to some embodiments, the estimation processor 118 can process video frames at a full FPS (e.g., every frame). In certain embodiments, the estimation processor 118 can integrate the various feeds into an estimate (e.g., a wholistic estimate). In some embodiments, the estimation processor 118 implements a Kalman filter algorithm and/or a similar algorithm to synthesize estimates of the geo-coordinates (e.g., true geo-coordinates) based on the various observations provided by the other processors (e.g., the calibration module, the optical flow processor 112, the georegistration processor 116, etc.). In certain embodiments, the visual navigation system 102 is adapted to the variable availability of the different streams, including dropouts or missing processors, continuing to provide the estimate (e.g., best available estimate) and predicted confidence. In some embodiments, the estimation processor 118 requires lightweight computational cost (e.g., a few milliseconds, a couple of milliseconds).

In certain embodiments, the visual navigation system 102 and/or the georegistration processor 116 includes a projection processor for projection. In some embodiments, the visual navigation system 102 projects against a DEM (digital elevation model). In certain embodiments, the projection processor is a standalone processor. In some embodiments, the projection processor is a part of the georegistration processor 116 and/or a part of the estimation processor 118.

In some embodiments, the visual navigation environment 100 includes a repository (not shown) can include and/or store videos, video frames, metadata, geolocation information, reference imagery, georegistration transforms, image-based transforms, and/or the like. The repository 430 may be implemented using any one of the configurations described below. A data repository may include random access memories, flat files, XML files, and/or one or more database management systems (DBMS) executing on one or more database servers or a data center. A database management system may be a relational (RDBMS), hierarchical (HDBMS), multidimensional (MDBMS), object oriented (ODBMS or OODBMS) or object relational (ORDBMS) database management system, and the like. The data repository may be, for example, a single relational database. In some cases, the data repository may include a plurality of databases that can exchange and aggregate data by data integration process or software application. In an exemplary embodiment, at least part of the data repository may be hosted in a cloud data center. In some cases, a data repository may be hosted on a single computer, a server, a storage device, a cloud server, or the like. In some other cases, a data repository may be hosted on a series of networked computers, servers, or devices. In some cases, a data repository may be hosted on tiers of data storage devices including local, regional, and central.

In some cases, various components in the visual navigation environment 100 can execute software or firmware stored in non-transitory computer-readable medium to implement various processing steps. Various components and processors of the visual navigation environment 100 can be implemented by one or more computing devices including, but not limited to, circuits, a computer, a cloud-based processing unit, a processor, a processing unit, a microprocessor, a mobile computing device, and/or a tablet computer. In some cases, various components of the visual navigation environment 100 (e.g., the visual navigation system 102, the visual navigation module 110, the SIP 120A/120B, user systems 132, control systems 134, location systems 136, etc.) can be implemented on a shared computing device. Alternatively, a component of the visual navigation environment 100 can be implemented on multiple computing devices. In some implementations, various modules and components of the visual navigation environment or workflow 100 can be implemented as software, hardware, firmware, or a combination thereof. In some cases, various components of the visual navigation environment or workflow 100 can be implemented in software or firmware executed by a computing device.

Various components of the visual navigation environment or workflow 100 can communicate via or be coupled to via a communication interface, for example, a wired or wireless interface. The communication interface includes, but is not limited to, any wired or wireless short-range and long-range communication interfaces. The short-range communication interfaces may be, for example, local area network (LAN), interfaces conforming known communications standard, such as Bluetooth® standard, IEEE 802 standards (e.g., IEEE 802.11), a ZigBee® or similar specification, such as those based on the IEEE 802.15.4 standard, or other public or proprietary wireless protocol. The long-range communication interfaces may be, for example, wide area network (WAN), cellular network interfaces, satellite communication interfaces, etc. The communication interface may be either within a private computer network, such as intranet, or on a public computer network, such as the internet.

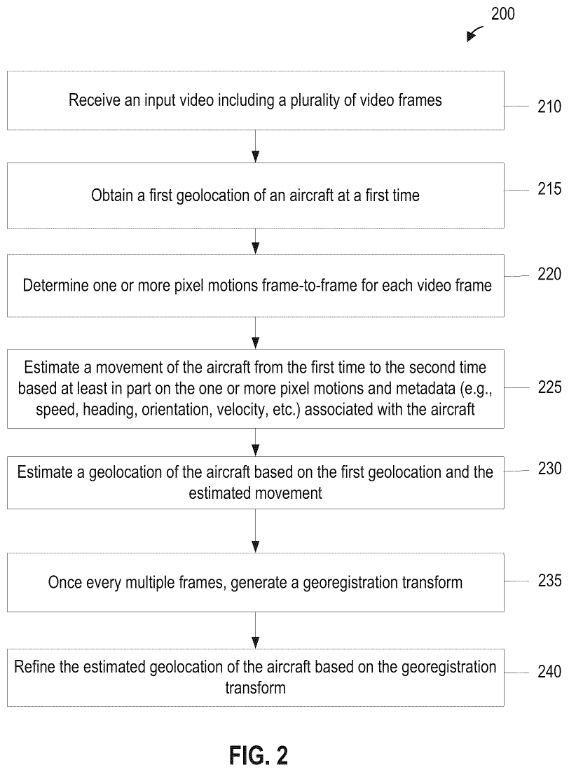

FIG. 2 is a simplified diagram showing a method 200 for visual navigation according to certain embodiments of the present disclosure. This diagram is merely an example. One of ordinary skill in the art would recognize many variations, alternatives, and modifications. The method 200 for visual navigation includes processes 210, 215, 220, 225, 230, 235, and 240. Although the above has been shown using a selected group of processes for the method 200 for visual navigation, there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

In some embodiments, some or all processes (e.g., steps) of the method 200 are performed by a system (e.g., the computing system 700). In certain examples, some or all processes (e.g., steps) of the method 200 are performed by a computer and/or a processor directed by a code. For example, a computer includes a server computer and/or a client computer (e.g., a personal computer). In some examples, some or all processes (e.g., steps) of the method 200 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to some embodiments, at process 210, the system receives an input video including a plurality of video frames. In certain embodiments, the plurality of video frames is a sequence of video frames. In some embodiments, at process 215, the system obtains a first geolocation of an aircraft (e.g., a drone, an UAV, etc.) at a first time, t1. In certain embodiments, the first geolocation is received from a GPS system.

According to certain embodiments, at process 220, the system determines one or more pixel motions frame-to-frame for each video frame in the plurality of video frames. In some embodiments, a pixel motion is an image-based motion that is a determined motion based on video frames, for example, image features in the video frames. In certain embodiments, at process 225, the system estimates a movement (e.g., displacement) of the aircraft from the first time, t1, to the second time, t2, based at least in part on the one or more pixel motions and metadata (e.g., speed, heading, orientation, velocity, etc.) associated with the aircraft. In some embodiments, the system estimates a geolocation of the aircraft based on the first geolocation and the estimated movement.

According to some embodiments, for every frame, the system estimates the geolocation of the aircraft based on the first geolocation and the estimated movement. For example, in a three-dimensional vector space, “geolocation of the aircraft at time t2”=“geolocation of the aircraft at time t1”+“movement of the aircraft from time t1 to time t2”

According to certain embodiments, at process 235, once every multiple frames, the system generates a georegistration transform (e.g., a georegistration technique using image matching, a georegistration technique using AWOG, etc.). In some embodiments, at process 240, the system refines the estimated geolocation of the aircraft based on the georegistration transform. In some embodiments, since the georegistration transform can be the conversion of a geographic location of a first image to the geographic location of a second image, then given a first image with a first geographic location, a second geographic location of a second image can be calculated using the georegistration transform. In certain embodiments, the system determines whether the use of the georegistration technique is accurate enough to justify consumption of additional computing power. In some embodiments, if yes, the process 240 is performed; if no, the process 240 is not performed. In some examples, the use of the georegistration technique at an area with less terrain features (e.g., “over water”) is not accurate enough to justify consumption of additional computing power.

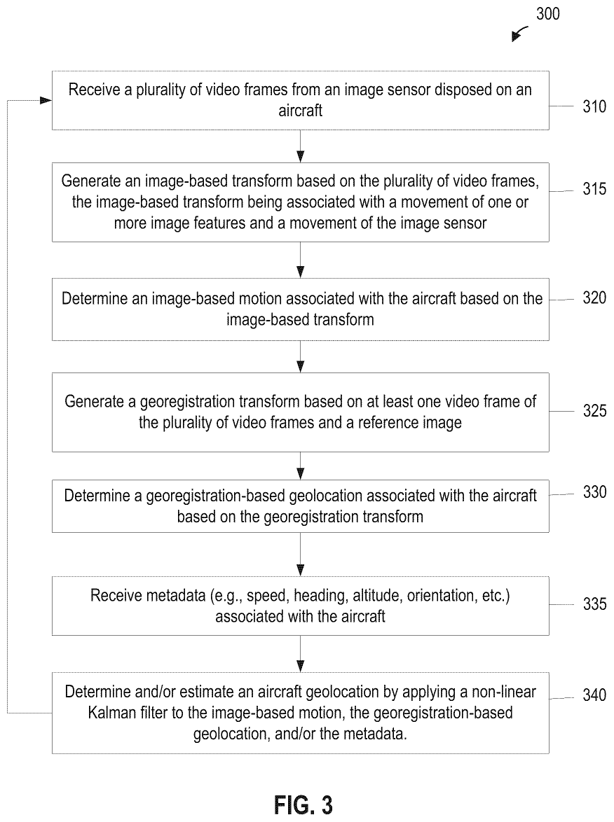

FIG. 3 is a simplified diagram showing a method 300 for visual navigation according to certain embodiments of the present disclosure. This diagram is merely an example. One of ordinary skill in the art would recognize many variations, alternatives, and modifications. The method 300 for visual navigation includes processes 310, 315, 320, 325, 330, 335, and 340. Although the above has been shown using a selected group of processes for the method 300 for visual navigation, there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

In some embodiments, some or all processes (e.g., steps) of the method 300 are performed by a system (e.g., the computing system 700). In certain examples, some or all processes (e.g., steps) of the method 300 are performed by a computer and/or a processor directed by a code. For example, a computer includes a server computer and/or a client computer (e.g., a personal computer). In some examples, some or all processes (e.g., steps) of the method 300 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to certain embodiments, at process 310, the system receives a plurality of video frames (e.g., images, image frames, etc.) from an image sensor disposed on an aircraft (e.g., a drone, an UAV, an UA, etc.). In some embodiments, the aircraft can move to GPS-denied environments, such as areas with GPS information. In certain embodiments, the aircraft's geolocation cannot be retrieved via a GPS system. In some embodiments, the system includes two or more image sensors. In certain embodiments, the system includes two or more image sensors disposed on the aircraft. In some embodiments, the two or more image sensors includes two or more types of sensors. In certain embodiments, the system can receive two or more types of video frames from the two or more types of sensors (e.g., EO sensors, infrared sensors, SAR sensors). In some embodiments, the system includes an SIP (e.g., the SIP 120A, the SIP 120B) to orchestrate sensor feeds and/or computing models. In certain embodiments, the SIP can perform one or more image transformations.

According to some embodiments, at process 315, the system generates an image-based transform based on the plurality of video frames. In certain embodiments, the image-based transform is associated with a movement of one or more image features and a movement of the image sensor. For example, in some embodiments, one or more features of a first image may be matched to one or more corresponding features of a second image, such that a movement of a position of the one or more features in the first image to a position of the corresponding one or more features in the second image is captured by the image-based transform. In some embodiments, the transform corresponds to the movement of features between images (e.g., calculated based on visual measurement of the movement of the features across images). In some embodiments, at process 320, the system determines an image-based motion associated with the aircraft based on the image-based transform.

In certain embodiments, the system analyzes a first video frame of the plurality of video frames to identify one or more first image features in the first video frame. In some embodiments, the system analyzes a second video frame of the plurality of video frames to identify one or more second image features in the second video frame, each second image feature of the one or more second image features matching one first image feature of the one or more first image features, the second video frame being after the first video frame in the plurality of video frames. In certain embodiments, the system generates one or more motion vectors based on the one or more first image features and the one or more second image features, where each motion vector of the one or more motion vectors corresponds to one of the one or more first image features and a matched second image features.

In some embodiments, the system determines a movement of the image sensor based on the image-based transform. In certain embodiments, the system generates (e.g., combines) the image-based transform based on the one or more motion vectors. Using the determined image-based motions, the system can determine and/or estimate a geolocation of the aircraft when the aircraft is at a GPS-denied area. In certain embodiments, the system is configured to determine the image-based transforms and motions at a first frame rate (e.g., every video frame, every other video frame, every M video frame, etc.). In some embodiments, the system is configured to determine the image-based transforms and/or motions at every video frame of the received plurality of video frames.

According some embodiments, at process 325, the system generates a georegistration transform based on at least one video frame of the plurality of video frames and a reference image (e.g., a reference image from the reference imagery 117, a reference image received). More details on the georegistration transform are provided throughout the present disclosure. In some embodiments, the georegistration transform is a transform between the geographic location of a first image and the geographic location of a second image. In certain embodiments, at process 330, the system determines a georegistration-based geolocation associated with the aircraft based on the georegistration transform. In some embodiments, since the georegistration transform can be associated with the transformation of a geographic location of a first image to the geographic location of a second image, then given a first image with a first geographic location, a second geographic location of a second image can be calculated using the georegistration transform. In some embodiments, the system determines the georegistration transform and/or the georegistration-based geolocation at a second frame rate.

In certain embodiments, the second frame rate is different from the first frame rate. In some embodiments, the second frame rate is lower than the first frame rate. In certain embodiments, the system determines the image-based transforms and motions for a first subset of video frames in the plurality of video frames. In some embodiments, the system determines the georegistration transform and/or the georegistration-based geolocation for a second subset of video frames in the plurality of video frames. In certain embodiments, the second subset of video frames is a smaller subset than the first subset of video frames. In some embodiments, at least one video frame in the first subset of video frames is not in the second subset of video frames. In some embodiments, the second frame rate is a dynamic frame rate that changes over time. In certain embodiments, the second frame rate is a dynamic frame rate depending on computing resources, for example, with sufficient computing resources to conduct a georegistration.

According to certain embodiments, at process 335, the system receives and/or extracts metadata associated with the aircraft. In some embodiments, the metadata is associated with a movement of the aircraft including, but not limited to, a speed, a heading, an altitude, an orientation, and/or the like. In certain embodiments, the system (e.g., the SIP) is configured to extract metadata from video frames. In some embodiments, the system is configured to extract at least a part of the metadata from at least one video frame of the plurality of video frames. In certain embodiments, the system associates at least a part of the metadata with at least one video frame of the plurality of video frames.

According to some embodiments, at process 340, the system determines and/or estimates an aircraft geolocation by applying a non-linear Kalman filter to the image-based motion, the georegistration-based geolocation, and/or the metadata. In certain embodiments, the non-linear Kalman filter includes an extended Kalman filter and/or an unscented Kalman filter. In some embodiments, the system determines and/or estimates an aircraft geolocation by applying a trained machine learning model (e.g., an estimation machine learning model) to the image-based motion, the georegistration-based geolocation, and/or the metadata.

According to certain embodiments, the system can process video frames received from two or more image sensors to determine an aircraft location. In some embodiments, the system can process video frames received from two or more types of image sensors to determine an aircraft location. In certain embodiments, the system determines two or image-based transforms and/or motions for the two or more sets of video frames received from the two or more image sensors. In some embodiments, the system determines the aircraft location based at least in part on the second image-based motions.

According to some embodiments, the system can receive aircraft locations from a GPS system at one or more certain times (e.g., when the aircraft is at a GPS available area, periodically when the aircraft is at a GPS available area, etc.). In certain embodiments, the system determines the aircraft geolocations at a later time based at least in part of the received aircraft locations. In some embodiments, the system goes back to the process 310 to continue receiving additional video frames (e.g., via a video stream) and determining the aircraft geolocation based at least in part on the additional video frames.

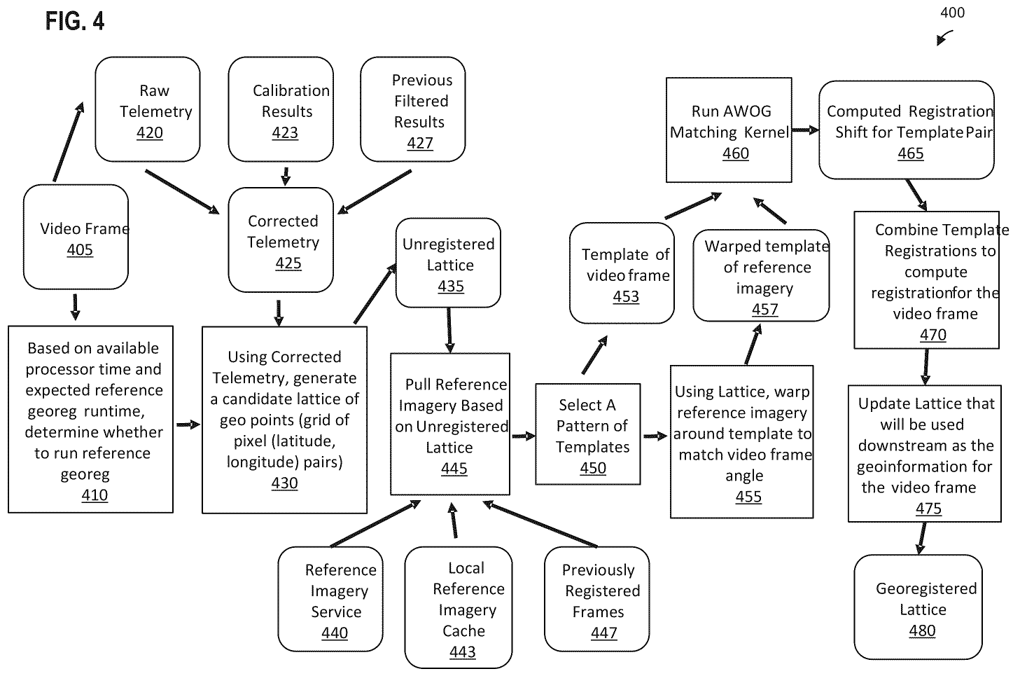

FIG. 4 is a simplified diagram showing a software architecture 400 for a video georegistration system according to certain embodiments of the present disclosure. This diagram is merely an example. One of ordinary skill in the art would recognize many variations, alternatives, and modifications. The architecture 400 for the video georegistration system includes components and processes 410, 420, 423, 425, 427, 430, 435, 440, 443, 445, 447, 450, 453, 455, 457, 460, 465, 470, 475 and 480. Although the above has been shown using a selected group of components and processes for the software architecture 400 for the video georegistration system, there can be many alternatives, modifications, and variations. For example, some of the components and/or processes may be expanded and/or combined. Other components and/or processes may be inserted into those noted above. Depending upon the embodiment, the sequence of processes may be interchanged with others replaced. Further details of these components and processes are found throughout the present disclosure.

According to some embodiments, the video georegistration system receives one or more videos or video streams including one or more video frames 405 (e.g., 30 frames-per-second (FPS), 60 FPS, etc.). In certain embodiments, at the process 410, the video georegistration system is configured to determine whether to run reference georegistration based on available processor time and expected reference georegistration runtime. In some embodiments, if the available processor time is lower than the expected reference georegistration runtime, the video georegistration system does not perform the reference georegistration. In certain embodiments, if the available processor time is greater than the expected reference georegistration runtime, the video georegistration system continues to perform the reference georegistration.

According to certain embodiments, the video georegistration system generates corrected telemetry 425 based on raw telemetry 420, calibrated results 423, and/or previous filtered results (e.g., Kalman filter aggregated results) 427. In some embodiments, the raw telemetry 420 is extracted from the received video, the video stream and/or a video frame of the one or more video frames 405. In certain embodiments, the calibration is to essentially clean up the video telemetry on the basis of common failure modes. In some embodiments, the calibration includes interpolating missing frames of the telemetry. In certain embodiments, the calibration includes lining up the video frames in case they came in staggered. In some embodiments, the calibration includes the ability to incorporate basically known corrections, such as previous filtered results 427. In certain embodiments, the calibration can correct some types of video feed exhibit systematic errors. In some examples, the systematic errors include an error in the field of view (e.g., the lens angle). For example, a lens angle of 5.1 degrees may actually be 5.25 degrees, and such deviation can be used in performing a calibration.

According to some embodiments, at the process 430, the video georegistration system generates a candidate lattice of geo points (e.g., grid of pixel (latitude, longitude) pairs) using corrected telemetry and generates unregistered lattice 435. In certain embodiments, at the process 445, the video georegistration system is configured to pull reference imagery based on unregistered lattice. In some embodiments, the video georegistration system uses reference imagery service 440, local reference imagery cache 443, and/or previously registered frames 447 to pull reference imagery. In certain embodiments, the video georegistration system can retrieve or generate reference imagery synchronously (e.g., within one hour) with the input video, for example, using the reference imagery service 440. In some embodiments, the video georegistration system can use local reference imagery cache 443 to retrieve reference imagery. In certain embodiments, the video georegistration system can use previously registered frames 447 (e.g., reference image used in previously registered frames).

According to certain embodiments, the reference imagery (e.g., reference image) can be generated based upon the geo-coordinates of the unregistered lattice. In some embodiments, the reference imagery is retrieved from the local reference imagery cache 443, for example, at the same edge device on which at least a part of the video georegistration system is running. In certain embodiments, the reference imagery is generated, stored, and/or retrieved from the same edge environment (e.g., on the physical plane). In some embodiments, the georegistration system avoids sending out requests for using, on high-latency connection. In certain embodiments, the georegistration system can use a pre-bundle set of tiles or shifted pre-bundle set of tiles as the reference imagery. In some embodiments, the georegistration system and/or another system support the generation (e.g., rapid generation) of localized base maps for reference imagery creation.

According to some embodiments, the georegistration system can couple a platform (e.g., a platform that harnesses satellite technology for autonomous decision making) with other available sources of satellite imagery to automatically pull the satellite images of an area (e.g., an area associated with the input video, an area associated with the video frame, an area associated with the unregistered lattice) and automatically build a base map in that area proximate in time (e.g., within four (4) hours, within one hour).

According to certain embodiments, at the process 450, the video georegistration system selects a pattern of templates and generates a template (e.g., a template slice) of the video frame 453. In some embodiments, at the process 455, the video georegistration system warps reference imagery around a template to match the video frame angle to generate a warped template (e.g., template slice) of reference imagery 457. In certain embodiments, at the process 460, the video georegistration system runs AWOG matching and/or other matching algorithm to the template and the warped template, also referred to as the template pair, to generates the computed registration shift for the template pair 465.

According to some embodiments, the video georegistration system recursively generates registrations for the templates. In certain embodiments, at the process 470, the video georegistration system combines template registrations to generate a frame registration (e.g., an image transform) for the video frame. In some embodiments, at the process 475, the video georegistration system updates the lattice using the frame registration to generate the georegistered lattice 480, which can be used downstream as the geoinformation for the video frame. In certain embodiments, the video georegistration system can use the frame registration to generate the georegistered video frame.

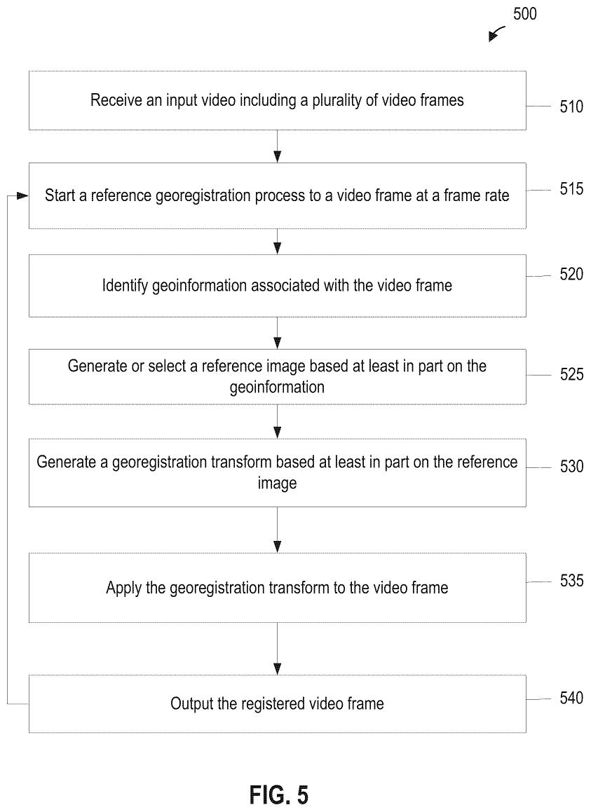

FIG. 5 is a simplified diagram showing a method 500 for video georegistration according to certain embodiments of the present disclosure. This diagram is merely an example. One of ordinary skill in the art would recognize many variations, alternatives, and modifications. The method 500 for sorting templates and/or generating a template queue includes processes 510, 515, 520, 525, 530, 535, and 540. Although the above has been shown using a selected group of processes for the method 500 for sorting templates and/or generating a template queue, there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

According to certain embodiments, at the process 510, the georegistration system receives an input video including a plurality of video frames. In certain embodiments, at the process 515, the video georegistration system is configured to start a reference georegistration process to a video frame at a frame rate. In some embodiments, the frame rate is a fixed frame rate. In certain embodiments, the frame rate is a dynamic frame rate (e.g., not a fixed frame rate). In some embodiments, the video georegistration system determines whether to run reference georegistration based on available processor time and expected reference georegistration runtime. In some embodiments, if the available processor time is lower than the expected reference georegistration runtime, the video georegistration system does not perform the reference georegistration. In certain embodiments, if the available processor time is greater than the expected reference georegistration runtime, the video georegistration system continues to perform the reference georegistration.

According to certain embodiments, at the process 520, the video georegistration system identifies geoinformation associated with the video frame. In some embodiments, the video georegistration system generates corrected telemetry based on raw telemetry, calibrated results, and/or previous filtered results (e.g., Kalman filtered results). In some embodiments, the raw telemetry is extracted from the received video, the video stream and/or a video frame of the one or more video frames. In certain embodiments, the calibration is to essentially clean up the video telemetry on the basis of common failure modes. In some embodiments, the calibration includes interpolating missing frames of the telemetry. In certain embodiments, the calibration includes lining up the video frames in case they came in staggered. In some embodiments, the calibration includes the ability to incorporate basically known corrections, such as previous filtered results. In certain embodiments, the calibration can correct some types of video feed that exhibit systematic errors.

According to some embodiments, the video georegistration system generates a candidate lattice of geo points (e.g., grid of pixel (latitude, longitude) pairs) using corrected telemetry and generates unregistered lattice. In certain embodiments, at the process 525, the video georegistration system is configured to generate or select a reference image based at least in part on the geoinformation associated with the video frame (e.g., unregistered lattice). In some embodiments, the video georegistration system uses reference imagery service, local reference imagery cache, and/or previously registered frames to pull reference imagery. In certain embodiments, the video georegistration system can retrieve or generate reference imagery synchronously (e.g., within one hour) with the input video, for example, using the reference imagery service. In some embodiments, the video georegistration system can use local reference imagery cache to retrieve reference imagery. In certain embodiments, the video georegistration system can use previously registered frames (e.g., reference imagery used in previously registered frames). In some embodiments, the video georegistration system can combine multiple images to generate the reference image.

According to certain embodiments, the reference image can be generated based upon the geo-coordinates of the unregistered lattice. In some embodiments, the reference imagery is retrieved from the local reference imagery cache, for example, at the same edge device on which at least a part of the video georegistration system is running. In certain embodiments, the reference image is generated, stored, and/or retrieved from the same edge environment (e.g., on the physical plane). In some embodiments, the georegistration system avoids sending out requests for using, on high-latency connection. In certain embodiments, the georegistration system can use a pre-bundle set of tiles or shifted pre-bundle set of tiles as the reference imagery. In some embodiments, the georegistration system and/or another system support the generation (e.g., rapid generation) of localized base maps for reference imagery creation.

According to some embodiments, the georegistration system can couple with a meta-constellation platform with other available sources of satellite imagery to automatically pull the satellite images of an area (e.g., an area associated with the input vide, an area associated with the video frame, an area associated with the unregistered lattice) and automatically build a base map in that area proximate in time (e.g., within four (4) hours, within one hour).

According to certain embodiments, at the process 530, the video georegistration system generates a georegistration transform based at least in part on the reference image. In some embodiments, the video georegistration system selects a pattern of templates and generates a template (e.g., a template slice) of the video frame. In some embodiments, the video georegistration system warps reference imagery around a template to match the video frame angle to generate a warped template (e.g., template slice) of reference imagery. In certain embodiments, the video georegistration system runs AWOG matching and/or other matching algorithm to the template and the warped template, also referred to as the template pair, to generates the computed registration shift for the template pair.

According to some embodiments, the video georegistration system recursively generates registrations for the templates. In certain embodiments, the video georegistration system combines template registrations to generate a frame registration (e.g., an image transform) for the video frame. In some embodiments, the video georegistration system updates the lattice using the frame registration to generate the georegistered lattice, which can be used downstream as the geoinformation for the video frame.

According to certain embodiments, at the process 535, the video georegistration system applies the georegistration transform to the video frame to generate the registered video frame (e.g., the georegistered video frame). In some embodiments, at the process 540, the video georegistration system outputs the registered video frame. In certain embodiments, the video georegistration system recursively conducts steps 515-540 to continuously generate georegistered video frames and/or georegistered videos.

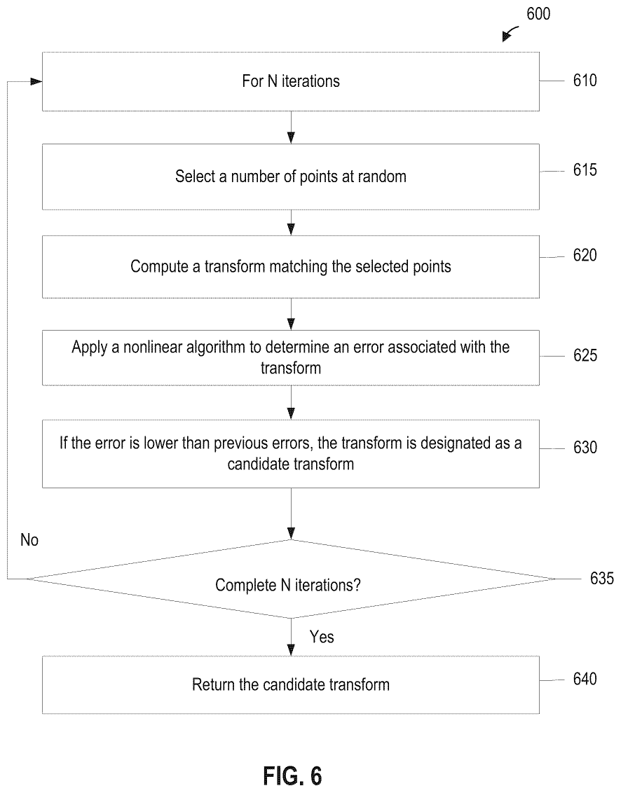

FIG. 6 is a simplified diagram showing a method 600 for generating a transformation (e.g., an image transformation) according to certain embodiments of the present disclosure. This diagram is merely an example. One of ordinary skill in the art would recognize many variations, alternatives, and modifications. The method 600 for generating a transformation (e.g., an image transformation) includes processes 610, 615, 620, 625, 630, 635, and 640. Although the above has been shown using a selected group of processes for the method 600 for generating a transformation (e.g., an image transformation), there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

According to certain embodiments, at the process 610, the georegistration system conducts image transformation computation for N iterations. In some embodiments, the georegistration system conducts image transformation computation with iterations. In certain embodiments, at the process 615, the georegistration system selects a number of points (e.g., 3 points) at random, at the process 620, the georegistration system computes a transform matching the selected points. In some embodiments, the georegistration system selects a predetermined number of points at random and computes the transform (e.g., affine transform) matching those selected points. In certain embodiments, the georegistration system selects one point for a translation.

According to some embodiments, at the process 625, the georegistration system applies a nonlinear algorithm (e.g., a Levenberg-Marquardt nonlinear algorithm) to determine an error associated with the transform. In certain embodiments, the georegistration system applies the nonlinear algorithm to the sum of the distances (e.g., Lorentz distances) between every point's shift value (e.g., preferred shift value). In certain embodiments, each point's shift value is weighted by each point's strength value in determining the error.

According to certain embodiments, at the process 630, if the error is lower than all previous transform, the transform is designated as a candidate transform (e.g., best candidate). In some embodiments, at the process 635, the georegistration system determines whether the N iterations have been completed. In certain embodiments, the georegistration system goes back to the process 610 if the N iterations have not been completed. In some embodiments, the georegistration system goes to the process 640 if the N iterations have been completed. In certain embodiments, at the process 640, the georegistration system returns the candidate transform (e.g., the best candidate transform).

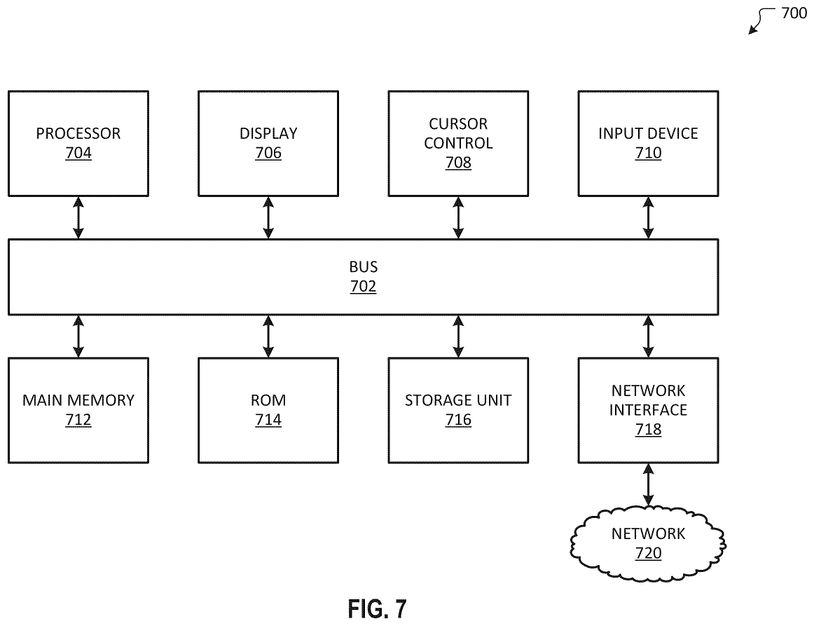

FIG. 7 is a simplified diagram showing a computing system for implementing a system 700 for georegistration in accordance with at least one example set forth in the disclosure. This diagram is merely an example, which should not unduly limit the scope of the claims. One of ordinary skill in the art would recognize many variations, alternatives, and modifications.

The computing system 700 includes a bus 702 or other communication mechanism for communicating information, a processor 704, a display 706, a cursor control component 708, an input device 710, a main memory 712, a read only memory (ROM) 714, a storage unit 716, and a network interface 718. In some embodiments, some or all processes (e.g., steps) of the methods/processes 200, 300, 400, 500, and/or 600 are performed by the computing system 700. In some examples, the bus 702 is coupled to the processor 704, the display 706, the cursor control component 708, the input device 710, the main memory 712, the read only memory (ROM) 714, the storage unit 716, and/or the network interface 718. In certain examples, the network interface is coupled to a network 720. For example, the processor 704 includes one or more general purpose microprocessors. In some examples, the main memory 712 (e.g., random access memory (RAM), cache and/or other dynamic storage devices) is configured to store information and instructions to be executed by the processor 704. In certain examples, the main memory 712 is configured to store temporary variables or other intermediate information during execution of instructions to be executed by processor 704. For examples, the instructions, when stored in the storage unit 716 accessible to processor 704, render the computing system 700 into a special-purpose machine that is customized to perform the operations specified in the instructions. In some examples, the ROM 714 is configured to store static information and instructions for the processor 704. In certain examples, the storage unit 716 (e.g., a magnetic disk, optical disk, or flash drive) is configured to store information and instructions.

In some embodiments, the display 706 (e.g., a cathode ray tube (CRT), an LCD display, or a touch screen) is configured to display information to a user of the computing system 700. In some examples, the input device 710 (e.g., alphanumeric and other keys) is configured to communicate information and commands to the processor 704. For example, the cursor control component 708 (e.g., a mouse, a trackball, or cursor direction keys) is configured to communicate additional information and commands (e.g., to control cursor movements on the display 706) to the processor 704.

According to certain embodiments, a method for video georegistration is provided. The method includes: receiving an input video including a plurality of video frames; calibrating a first set of video frames selected from the plurality of video frames to generate a first set of calibrated video frames using a calibration transform; performing one or more reference georegistrations to a second set of video frames selected from the plurality of video frames to generate a video georegistration transform using the second set of video frames, the second set of video frames having fewer video frames than the first set of video frames; generating an output video using the calibration transform and the video georegistration transform; wherein the method is performed using one or more processors. For example, the method is implemented according to at least FIG. 1, FIG. 2, FIG. 3, FIG. 4, and/or FIG. 5.

In some embodiments, the video transform includes one or more video frame transforms corresponding to the second set of video frames. In certain embodiments, the method further includes: applying an optical flow estimation to a third set of video frames of the plurality of the video frames; wherein the third set of video frames has fewer video frames than the first set of video frames and more video frames than the second set of video frames.

According to some embodiments, a method for visual navigation is provided. The method includes: receiving a plurality of video frames from an image sensor disposed on an aircraft; generating an image-based transform based on the plurality of video frames, the image-based transform being associated with a movement of one or more image features and a movement of the image sensor; determining an image-based motion associated with the aircraft based on the image-based transform; generating a georegistration transform based on at least one video frame of the plurality of video frames and a reference image; determining a georegistration-based geolocation associated with the aircraft based on the georegistration transform; and determining an aircraft geolocation by applying a non-linear Kalman filter to the image-based motion and the georegistration-based geolocation, wherein the method is performed using one or more processors. For example, the method is implemented according to at least FIG. 1, FIG. 2, FIG. 3, and/or FIG. 4.

In certain embodiments, the method further includes: receiving metadata associated with a movement of the aircraft; wherein the metadata includes at least one of a speed, a heading, an altitude, and an orientation; wherein the determining an aircraft location includes determining the aircraft location by applying the non-linear Kalman filter to the image-based motion, the georegistration-based geolocation, and the metadata. In some embodiments, the method further includes extracting at least a part of the metadata from at least one video frame of the plurality of video frames. In certain embodiments, the non-linear Kalman filter is an unscented Kalman filter. In some embodiments, the generating an image-based transform includes: analyzing a first video frame of the plurality of video frames to identify one or more first image features in the first video frame; analyzing a second video frame of the plurality of video frames to identify one or more second image features in the second video frame, each second image features of the one or more second image features matching one first image feature of the one or more first image features, the second video frame being after the first video frame in the plurality of video frames; generating one or more motion vectors based on the one or more first image features and the one or more second image features, each motion vector of the one or more motion vectors corresponding to one of the one or more first image features and a matched second image features; generating the image-based transform based on the one or more motion vectors.

In certain embodiments, the generating an image-based transform includes generating one or more image-based transforms for a first set of video frames at a first frame rate; wherein the generating a georegistration transform includes generating the georegistration transform for a second set of video frames at a second frame rate; wherein the first frame rate is different from the second frame rate. In some embodiments, the first frame rate is higher than the second frame rate; wherein the second set of video frames is a subset of the plurality video frames. In certain embodiments, the first frame rate is higher than the second frame rate; wherein the first set of video frames includes each video frame of the plurality video frames. In some embodiments, the method further includes: determining a movement of the image sensor based on the image-based transform.

In certain embodiments, the plurality of video frames are a first plurality of video frames; wherein the image sensor is a first image sensor; wherein the method further includes: receiving a second plurality of video frames from a second image sensor, the second image sensor being different from the first image sensor; generating a second image-based transform based on the second plurality of video frames; determining a second image-based motion associated with the aircraft based on the second image-based transform; and determines the aircraft geolocation based at least in part on the second image-based motion. In some embodiments, the method further includes: receiving a first aircraft location; wherein the determining an aircraft geolocation comprises determining the aircraft location based at least in part on the first aircraft location.

According to some embodiments, a system for visual navigation is provided. In some embodiments, the system includes at least one processor and at least one memory storing instructions that, when executed by the at least one processor, cause the system to perform a set of operations. In some embodiments, the set of operations includes: receiving a plurality of video frames from an image sensor disposed on an aircraft, and generating an image-based transform based on the plurality of video frames. In some embodiments, the image-based transform is associated with a movement of one or more image features and a movement of the image sensor. In some embodiments, the set of operations further includes: determining an image-based motion associated with the aircraft based on the image-based transform, generating a georegistration transform based on at least one video frame of the plurality of video frames and a reference image, determining a georegistration-based geolocation associated with the aircraft based on the georegistration transform, and determining an aircraft geolocation by applying a non-linear Kalman filter to the image-based motion and the georegistration-based geolocation.

In some embodiments, the set of operations includes receiving metadata associated with a movement of the aircraft, wherein the metadata includes at least one selected from a group consisting of a speed, a heading, an altitude, and an orientation, and wherein the determining an aircraft location comprises determining the aircraft location by applying the non-linear Kalman filter to the image-based motion, the georegistration-based geolocation, and the metadata. In some embodiments, the set of operations includes extracting at least a part of the metadata from at least one video frame of the plurality of video frames.

In some embodiments, the non-linear Kalman filter is an unscented Kalman filter. In some embodiments, the generating an image-based transform includes: analyzing a first video frame of the plurality of video frames to identify one or more first image features in the first video frame and analyzing a second video frame of the plurality of video frames to identify one or more second image features in the second video frame. In some embodiments, each second image features of the one or more second image features matches one first image feature of the one or more first image features. In some embodiments, the second video frame is after the first video frame in the plurality of video frames. In some embodiments, the generating an image-based transform further includes: generating one or more motion vectors based on the one or more first image features and the one or more second image features. In some embodiments, each motion vector of the one or more motion vectors corresponds to one of the one or more first image features and a matched second image features. In some embodiments, the generating an image-based transform further includes generating the image-based transform based on the one or more motion vectors.

In some embodiments, the generating an image-based transform includes generating one or more image-based transforms for a first set of video frames at a first frame rate. In some embodiments, the generating a georegistration transform includes generating the georegistration transform for a second set of video frames at a second frame rate. In some embodiments, the first frame rate is different from the second frame rate. In some embodiments, the set of operations further includes determining a movement of the image sensor based on the image-based transform.

According to some embodiments, a method for visual navigation is provided. In some embodiments, the method includes: receiving a plurality of video frames from an image sensor disposed on an aircraft, and generating an image-based transform based on the plurality of video frames. In some embodiments, the image-based transform is associated with a movement of one or more image features and a movement of the image sensor. In some embodiments, the method further includes: determining an image-based motion associated with the aircraft based on the image-based transform, generating a georegistration transform based on at least one video frame of the plurality of video frames and a reference image, determining a georegistration-based geolocation associated with the aircraft based on the georegistration transform, receiving metadata associated with the aircraft, and estimating an aircraft geolocation by applying a non-linear Kalman filter to the image-based motion, the georegistration-based geolocation, and the metadata. In some embodiments, the method is performed using one or more processors.

In some embodiments, the metadata includes a speed, a heading, and an altitude of the aircraft.

For example, some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In yet another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system (e.g., one or more components of the processing system) to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented, for example, as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments. Various modifications and alterations of the disclosed embodiments will be apparent to those skilled in the art. The embodiments described herein are illustrative examples. The features of one disclosed example can also be applied to all other disclosed examples unless otherwise indicated. It should also be understood that all U.S. patents, patent application publications, and other patent and non-patent documents referred to herein are incorporated by reference, to the extent they do not contradict the foregoing disclosure.

What is claimed is:

1. A method for visual navigation, the method comprising:
receiving a plurality of video frames from an image sensor disposed on an aircraft;
generating an image-based transform based on the plurality of video frames, the image-based transform being associated with a movement of one or more image features and a movement of the image sensor;
determining an image-based motion associated with the aircraft based on the image-based transform;
generating a georegistration transform based on at least one video frame of the plurality of video frames and a reference image;
determining a georegistration-based geolocation associated with the aircraft based on the georegistration transform; and
determining an aircraft geolocation by applying a non-linear Kalman filter to the image-based motion and the georegistration-based geolocation,
wherein the method is performed using one or more processors.

2. The method of claim 1, further comprising:
receiving metadata associated with a movement of the aircraft,
wherein the metadata includes at least one selected from a group consisting of a speed, a heading, an altitude, and an orientation; and
wherein the determining an aircraft location comprises determining the aircraft location by applying the non-linear Kalman filter to the image-based motion, the georegistration-based geolocation, and the metadata.

3. The method of claim 2, further comprising:
extracting at least a part of the metadata from at least one video frame of the plurality of video frames.

4. The method of claim 1, wherein the non-linear Kalman filter is an unscented Kalman filter.

5. The method of claim 1, wherein the generating an image-based transform includes:
analyzing a first video frame of the plurality of video frames to identify one or more first image features in the first video frame;
analyzing a second video frame of the plurality of video frames to identify one or more second image features in the second video frame, each second image features of the one or more second image features matching one first image feature of the one or more first image features, the second video frame being after the first video frame in the plurality of video frames;
generating one or more motion vectors based on the one or more first image features and the one or more second image features, each motion vector of the one or more motion vectors corresponding to one of the one or more first image features and a matched second image features; and
generating the image-based transform based on the one or more motion vectors.

6. The method of claim 1, wherein the generating an image-based transform comprises generating one or more image-based transforms for a first set of video frames at a first frame rate;
wherein the generating a georegistration transform comprises generating the georegistration transform for a second set of video frames at a second frame rate; and
wherein the first frame rate is different from the second frame rate.

7. The method of claim 6, wherein the first frame rate is higher than the second frame rate; wherein the second set of video frames is a subset of the plurality of video frames.

8. The method of claim 6, wherein the first frame rate is higher than the second frame rate; wherein the first set of video frames includes each video frame of the plurality of video frames.

9. The method of claim 1, further comprising:
determining a movement of the image sensor based on the image-based transform.

10. The method of claim 1, wherein the plurality of video frames are a first plurality of video frames; wherein the image sensor is a first image sensor; and
wherein the method further comprises:
receiving a second plurality of video frames from a second image sensor, the second image sensor being different from the first image sensor;
generating a second image-based transform based on the second plurality of video frames;
determining a second image-based motion associated with the aircraft based on the second image-based transform; and
determining the aircraft geolocation based at least in part on the second image-based motion.

11. The method of claim 1, further comprising:
receiving a first aircraft location,
wherein the determining an aircraft geolocation comprises determining the aircraft location based at least in part on the first aircraft location.

12. A system for visual navigation, the system comprising:
at least one processor; and
at least one memory storing instructions that, when executed by the at least one processor, cause the system to perform a set of operations, the set of operations comprising:
receiving a plurality of video frames from an image sensor disposed on an aircraft;
generating an image-based transform based on the plurality of video frames, the image-based transform being associated with a movement of one or more image features and a movement of the image sensor;
determining an image-based motion associated with the aircraft based on the image-based transform;
generating a georegistration transform based on at least one video frame of the plurality of video frames and a reference image;
determining a georegistration-based geolocation associated with the aircraft based on the georegistration transform; and
determining an aircraft geolocation by applying a non-linear Kalman filter to the image-based motion and the georegistration-based geolocation.

13. The system of claim 12, wherein the set of operations further comprises:
receiving metadata associated with a movement of the aircraft,
wherein the metadata includes at least one selected from a group consisting of a speed, a heading, an altitude, and an orientation, and
wherein the determining an aircraft location comprises determining the aircraft location by applying the non-linear Kalman filter to the image-based motion, the georegistration-based geolocation, and the metadata.

14. The system of claim 13, wherein the set of operations further comprises:
extracting at least a part of the metadata from at least one video frame of the plurality of video frames.

15. The system of claim 12, wherein the non-linear Kalman filter is an unscented Kalman filter.

16. The system of claim 12, wherein the generating an image-based transform includes:
analyzing a first video frame of the plurality of video frames to identify one or more first image features in the first video frame;
analyzing a second video frame of the plurality of video frames to identify one or more second image features in the second video frame, each second image features of the one or more second image features matching one first image feature of the one or more first image features, the second video frame being after the first video frame in the plurality of video frames;
generating one or more motion vectors based on the one or more first image features and the one or more second image features, each motion vector of the one or more motion vectors corresponding to one of the one or more first image features and a matched second image features; and
generating the image-based transform based on the one or more motion vectors.

17. The system of claim 12, wherein the generating an image-based transform comprises generating one or more image-based transforms for a first set of video frames at a first frame rate;
wherein the generating a georegistration transform comprises generating the georegistration transform for a second set of video frames at a second frame rate; and
wherein the first frame rate is different from the second frame rate.

18. The system of claim 12, wherein the set of operations further comprises;
determining a movement of the image sensor based on the image-based transform.

19. A method for visual navigation, the method comprising:
receiving a plurality of video frames from an image sensor disposed on an aircraft;
generating an image-based transform based on the plurality of video frames, the image-based transform being associated with a movement of one or more image features and a movement of the image sensor;
determining an image-based motion associated with the aircraft based on the image-based transform;
generating a georegistration transform based on at least one video frame of the plurality of video frames and a reference image;
determining a georegistration-based geolocation associated with the aircraft based on the georegistration transform;
receiving metadata associated with the aircraft; and
estimating an aircraft geolocation by applying a non-linear Kalman filter to the image-based motion, the georegistration-based geolocation, and the metadata,
wherein the method is performed using one or more processors.

20. The method of claim 19, wherein the metadata includes at least one selected from a group consisting of a speed, a heading, and an altitude of the aircraft.
